(19) United States
(12) Patent Application Publication
(10) Pub. No.: US 2010/0038210 A1
(43) Pub. Date: Feb. 18, 2010

(54) CONVEYING APPARATUS FOR THE CONVEYING OF BEVERAGE BOTTLES FROM A BEVERAGE BOTTLE TREATMENT MACHINE TO A BEVERAGE BOTTLE PACKAGING MACHINE IN A BEVERAGE BOTTLING PLANT, AND A CONVEYING APPARATUS FOR THE CONVEYING OF PRODUCTS FROM A PRODUCT TREATMENT MACHINE TO A PRODUCT PACKAGING MACHINE

(76) Inventors: Bernd COX, Weeze (DE); Stefan WILLEMSEN, Weeze (DE)

Correspondence Address: NILS H. LJUNGMAN & ASSOCIATES, P. O. BOX 130, GREENSBURG, PA, 15601-0130, US

(21) Appl. No.: 12/372,252

(22) Filed: Feb. 17, 2009

Related U.S. Application Data
(63) Continuation-in-part of application No. PCT/EP2007/007205, filed on Aug. 16, 2007.

(30) Foreign Application Priority Data
Aug. 19, 2006 (DE) 10 2006 039 086.5

(51) Int. Cl. B65G 47/31

(52) U.S. Cl. 198/460.1

(57) ABSTRACT

A conveying apparatus for the conveying of beverage bottles from a beverage bottle treatment machine to a beverage bottle packaging machine in a beverage bottling plant, and a conveying apparatus for the conveying of products from a product treatment machine to a product packaging machine. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2007/007205, filed on Aug. 16, 2007, which claims priority from Federal Republic of Germany Patent Application No. 10 2006 039 086.5, filed on Aug. 19, 2006. International Patent Application No. PCT/EP2007/007205 was pending as of the filing date of this application. The United States was an elected state in International Patent Application No. PCT/EP2007/007205.

### BACKGROUND

1. Technical Field

The present application relates to a conveying apparatus for the conveying of beverage bottles from a beverage bottle treatment machine to a beverage bottle packaging machine in a beverage bottling plant, and a conveying apparatus for the conveying of products from a product treatment machine to a product packaging machine.

2. Background Information

Background information is for informational purposes only and does not necessarily admit that subsequently mentioned information and publications are prior art.

In conveyor lines for products of different sorts such as, for example, containers, packaging units etc., meter belts are frequently required and/or desired and are used, for example, to form a multiple-lane product stream from, for example, an initially unorganized product stream or a narrow product stream, and possibly by distributing the products as uniformly as possible over the tracks or lanes of the multiple-lane product stream. A frequent application for such meter belts is the uniform distribution of the products being conveyed into the individual lanes of a multiple-lane conveyor which forms the inlet of a packaging machine or a machine for the assembly of packaging units.

The meter belt comprises a plurality of conveyor belts, each of which forms a closed loop and can be driven in endless circulation, and which are arranged so that the upper lengths of their loops are laterally adjacent to one another, thereby forming a common horizontal or essentially horizontal transport surface.

To achieve the uniform distribution of the products into the individual tracks or lanes of a connected conveyor, on some meter belts, each conveyor belt has its own drive mechanism. By means of these drive mechanisms, the transport speed of the individual conveyor belts can be controlled individually, and possibly, for example, as a function of sensor signals which are supplied by sensors that monitor the distribution of the products over the individual tracks or lanes of the downstream conveyor.

Because meter belts are generally realized with at least four or six strands, i.e. they have at least four or six conveyor belts, the individual drive mechanisms for the individual conveyor belts require and/or desire a great deal of effort and expense in terms of design, construction and regulation and take up a great deal of space.

Some apparatuses and methods for the reforming of a row of containers exiting a container treatment machine involves incorporating containers in a single file and standing upright on a transport medium, e.g. a row of bottles, into a multiple-row stream of containers moving at a slow speed. In a first step, the speed of the containers in the single-file row is reduced, beginning close to the exit from the container treatment machine to close any gaps between the containers. Immediately or generally thereafter, by means of a further reduction of the speed, the row of containers is reformed into a multiple-lane stream of containers. For the realization of this function, the bottles are guided transversely by means of a plurality of conveyor belts located parallel or virtually parallel next to one another, whereby these conveyor belts are each moving at decreasing speeds, i.e. they run slower in steps, as a result of which the speed of the bottles is reduced. Some methods use different speeds of the conveyor belts that run at step-wise slower speeds.

Some apparatuses for the reforming of a multiple-lane stream of containers into a plurality of single-file rows of containers use a feed device for the container stream, a plurality of outward conveyors for the rows of containers, an intermediate area downstream of the feed conveyor which has a plurality of tracks, each with two lanes, separated from one another by parallel or virtually parallel guide rails, and with a separation area which connects the intermediate area with the outward conveyors and has a plurality of tracks separated from one another by guide rails, whereby each track narrows from two to one lane, whereby each track of the intermediate area has a separate conveyor with its own variable-speed drive which can be controlled by at least one container feeler which is located in an area that corresponds to the track associated with the intermediate area and/or the separation area. In these apparatuses, the variable-speed drive provides the different speeds.

One disadvantage of these apparatuses is that each conveyor belt has its own variable-speed drive motor, which is expensive and complex.

### OBJECT OR OBJECTS

An object of the present application is to create a meter belt which eliminates these disadvantages. The present application teaches that this object can be accomplished by a meter belt for use in a conveyor line for the transport of products, with at least two endless conveyor belts that can be driven in circulation and form a loop, which conveyor belts, with the respective upper lengths of their loops laterally adjacent to one another, form a common transport surface for the products, whereby the speed of circulation and thus the transport speed of at least one conveyor belt can be set individually. The drive system is formed by a single drive motor, and that a gearing in the form of a transmission is realized that connects the conveyor belts so that they are driven by the drive motor so that the speed of at least one conveyor belt can be varied in steps by changing gears.

### SUMMARY

The present application relates to a meter belt for use in a conveyor line for the transport of products, with at least two endless conveyor belts that can be driven in circulation and form a loop, which conveyor belts, with the respective upper lengths of their loops laterally adjacent to one another, form a common transport surface for the products, whereby the speed of circulation and thus the transport speed of at least one conveyor belt can be set individually. The drive system is formed by a single drive motor, and that a gearing in the form of a transmission is realized that connects the conveyor belts so that they are driven by the drive motor so that the speed of at least one conveyor belt can be varied in steps by changing gears.

On the meter belt according to the present application, one single drive motor (electric motor) or geared motor is provided for the drive of the conveyor belts. By means of the transmission, at least one conveyor belt or at least some of the conveyor belts used can be switched individually in steps between at least two transport speeds, namely between a low transport speed and a higher transport speed, although in one possible embodiment all or substantially all or most of the conveyor belts of the meter belt can be switched between a low speed and a higher speed in such a manner.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Developments of the present application are described according to the present application. The present application is explained in greater detail below with reference to one possible embodiment which is illustrated in the accompanying figures, in which:

FIG. 1 is a simplified plan view of a six-strand meter belt according to the present application for the feed of products into lanes of a downstream conveyor, for example into lanes of a feed belt of a packaging machine, whereby three of the total of six individual conveyor belts or conveyor chains are shown;

FIG. 2 a side view of the meter belt illustrated in FIG. 1;

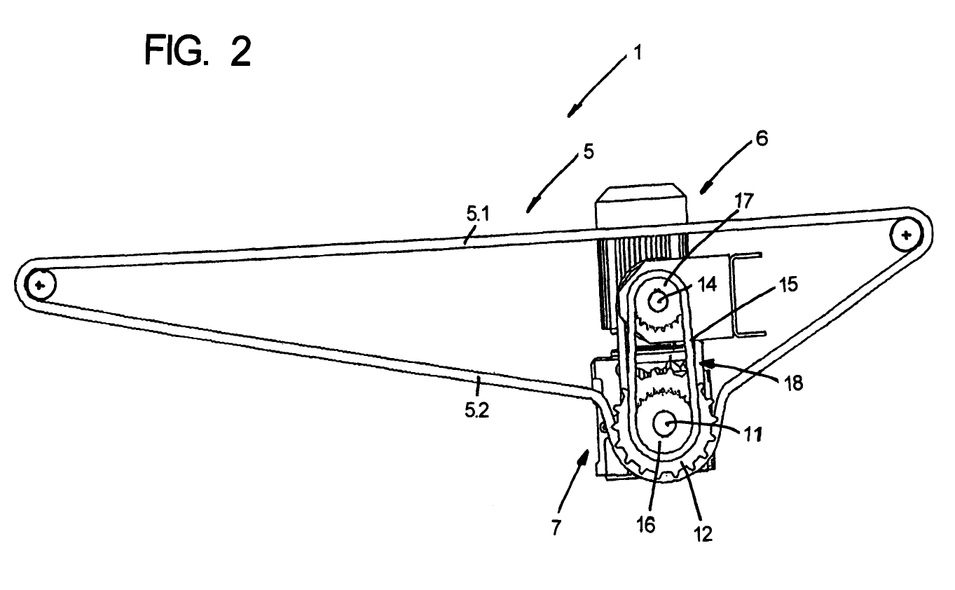

FIG. 3 is a perspective view showing the essential elements of the meter belt illustrated in FIGS. 1 and 2;

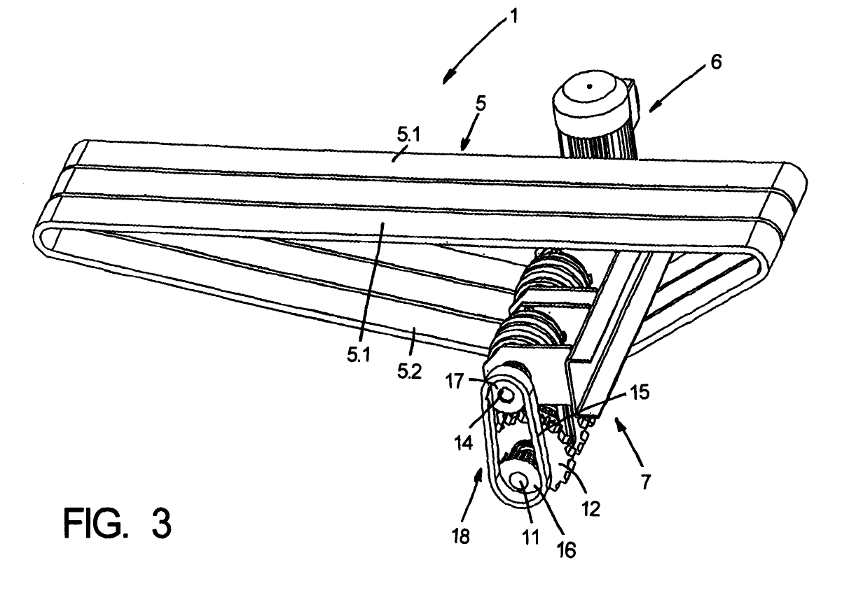

FIG. 4 is a detail showing the drive system of the meter belt illustrated in FIGS. 1 through 3 with the transmission;

FIG. 5 shows schematically the main components of one possible embodiment example of a system for filling containers, specifically, a beverage bottling plant for filling bottles with at least one liquid beverage, in accordance with at least one possible embodiment, in which system or plant could possibly be utilized at least one aspect, or several aspects, of the embodiments disclosed herein;

FIG. 6 shows the conveyor of the present application, which transports bottles or similar beverage containers from a treatment machine to a packaging machine, including a plurality of sensors;

FIG. 7 shows the conveyor of the present application, which closely groups rows of bottles or similar beverage containers into tight rows; and

FIG. 8 shows a meter belt of the present application with two conveyor chains or conveyor belts.

### DESCRIPTION OF EMBODIMENT OR EMBODIMENTS

The meter belt, which is designated 1 in general in the accompanying figures, is used for the feed of products 2 to the individual lanes 3 of a conveyor 4 which is connected to the meter belt downstream in the direction of transport A, which conveyor 4 is the inlet or the feed belt of a packaging machine for the packaging of the products 2 or for the assembly of these products into a bundle. In the illustrated embodiment, the meter belt 1 is realized in the form of a six-strand belt, i.e. it comprises six individual conveyor belts or conveyor chains 5 which are oriented parallel or virtually parallel to one another and are adjacent to one another laterally, whereby each strand forms a closed loop and with the upper strands 5.1 of their loops which are laterally adjacent to one another form a horizontal or essentially horizontal transport surface for the products 2. The conveyor chains 5 are driven in circulation by a common electric or geared motor 6 by means of a transmission 7, so that the upper loop length 5.1 of each conveyor chain 5 moves in the direction of transport A of the meter belt 1. Immediately or generally downstream of each conveyor chain 5 in the direction of transport A is a lane 3 of the conveyor 4, each (lane) of which is formed by a conveyor belt 8 and by the rails 9 that form the lateral boundaries of the lane.

To essentially ensure or promote that all or substantially all or most of the lanes 3 are filled as uniformly as possible with the products 2, i.e. so that the products 2 in the lanes 3 are in contact with one another in a single-file row with the most uniform possible dynamic pressure, the individual conveyor chains 5 can be driven in steps at different speeds, and in one possible embodiment under the control of an electronic control device 10 and, for example, as a function of sensor signals which are supplied by the sensors that monitor the distribution of the products 2 in the lanes 3.

In the illustrated embodiment, the conveyor chains 5 can each be driven at two different speeds by means of the transmission 7, and in one possible embodiment at a speed which corresponds to the speed of rotation n1 of the output shaft of the geared motor 6 and an elevated speed which corresponds to an elevated speed of rotation n2 for the drive of the conveyor chains 5 and is approximately twenty percent higher than the speed of rotation n1. In one possible embodiment of the present application, the speed of rotation n1 is approximately ten percent lower than a nominal speed of rotation, i.e. lower than the speed of rotation at which the transport speed of the conveyor chains 5 is equal to the speed of transport of the conveyor 4 or of the conveyor belts 8 that make up the conveyor. The higher speed of rotation n2, with the assumed difference of twenty percent between the speeds of rotation, is therefore approximately ten percent higher than this nominal speed of rotation.

The transmission 7 is realized so that for each conveyor chain 5 on a main drive shaft 11 which is connected in a driving relationship with the output shaft of the geared motor 6, has a conveyor belt or conveyor chain drive wheel 12 which is realized in the form of a sprocket wheel, by means of which the bottom loop strand 5.2 of the conveyor chain in question is guided with sufficient wrapping. At the reduced speed of transport of the associated conveyor chain 5, the individual conveyor chain drive wheel 12 is driven at the speed n1 directly by the main drive shaft 11 by means of a freewheel mechanism 13. At the elevated speed of transport of the associated conveyor chain 5, the conveyor chain drive wheel 12 is driven by means of a controllable drive train which is inside the transmission with an over-revving of the freewheel mechanism 13 at the speed of rotation n2 which is higher than the speed of rotation n1.

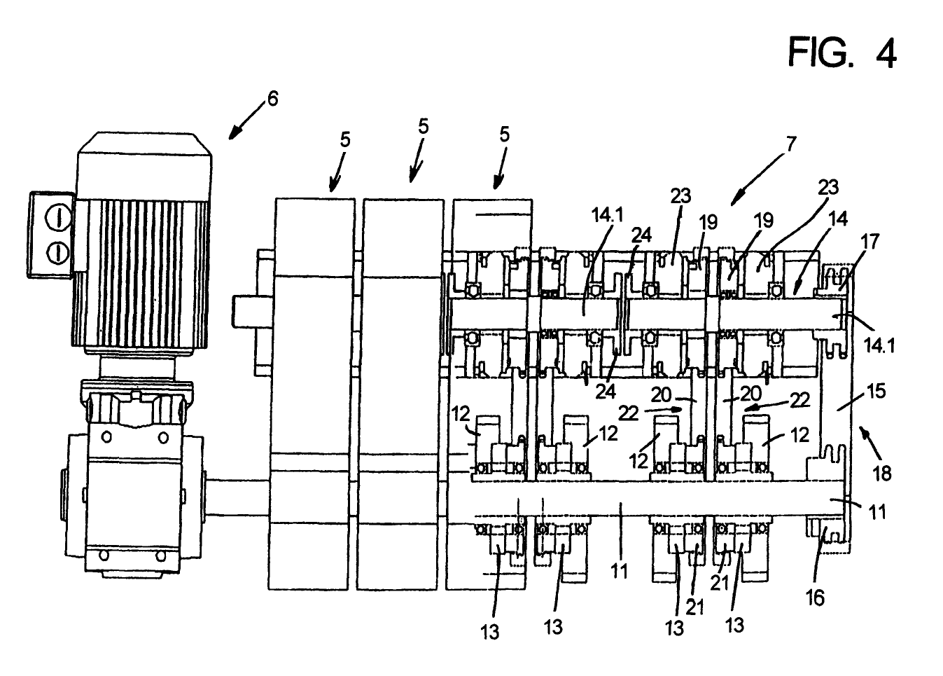

The realization of the transmission 7 is illustrated in greater detail in FIG. 4. All or substantially all or most of the conveyor chain drive wheels 12 are connected in a driving relationship via a freewheel mechanism 13 with the main drive shaft 11. The transmission 7 has a lay shaft 14 which is oriented parallel or virtually parallel to the main drive shaft 11, but is radially offset from it and is mounted so that it can rotate in a housing (not shown) of the transmission 7 and is connected by means of a toothed belt 15 and the associated belt sprockets 16 and 17 to the main drive shaft 11 and to the toothed belt drive 18 formed by the lay shaft 14 with the main shaft 11. For each conveyor chain 5 and for each conveyor chain drive wheel 12, on the lay shaft 14 there is a toothed belt sprocket 19 which is a component of a toothed belt drive 22 which has a toothed belt 20 and a belt sprocket 21, and which, under the control of the control device 10, can be connected via an electrically actuated coupling 23 to the lay shaft 14 or can be uncoupled from it. Each belt sprocket 21 is further connected in a driving relationship with the associated conveyor chain drive wheel 12.

The translation ratios of the toothed belt drives 18 and 20 are selected so that with a belt sprocket 19 which is connected by means of the coupling 23 in a drive relationship with the lay shaft 14, the conveyor chain drive wheel 12 which is driven by means of the associated toothed belt drive 23 circulates with over-revving of the freewheel mechanism 13 at the elevated speed n2, and when the toothed belt drive 22 is uncoupled from the lay shaft 14 is driven via the freewheel mechanism at the speed n1 of the main drive shaft 11. An independent toothed belt drive 22 is associated with each conveyor chain 5 or each conveyor chain drive wheel 12. The toothed belt drive 18 is provided in common for all or substantially all or most the conveyor chains 5 and conveyor chain drive wheels 12.

The toothed belt drives 18 and 20 are in one possible embodiment selected so that the toothed belt drives 20 each have a translation ratio of 1:1 and the speed of rotation n2 which is higher than the speed of rotation n1 of the main drive shaft 11, for example the speed of rotation n2 which is higher by twenty percent is achieved by the translation ratio of the common toothed belt drive 18.

The meter belt 1 makes possible an individual variation in the speed of the individual conveyor chains 5 in spite of the use of one geared motor 6. This results in a simplified and cost-saving realization of the meter belt 1, and in one possible embodiment one that has the capability of optimally controlling the filling of the lanes 3 with the products 2. A plurality of drive motors, drive shafts, control units etc. of the type required or desired on controllable meter belts of other apparatuses are no longer required and/or desired. As a result of the realization according to the present application, the construction also occupies a relatively small amount of space.

As illustrated in FIG. 4, the lay shaft 14 is segmented, i.e. it comprises a plurality of segments 14′ which are adjacent to one another on the ends and are connected to one another, on each of which segments two couplings 23 and two toothed belt sprockets 19 are provided. As a result of this segmented realization, when standard assemblies are used, transmissions 7 can optionally be realized for meter belts with two, four or six strands, for example.

As further illustrated in FIG. 4, the toothed belt drives 22 of two neighboring conveyor chain drive wheels 12 are provided between each of these drive wheels, so that at the distance between the conveyor chain drive wheels 12 specified by the width of the chain conveyors 5 there remains sufficient space on the main drive shaft 11 for the electrically actuated couplings 23 and for the flange 24 that connects the segments 14.1 of the lay shaft on the ends.

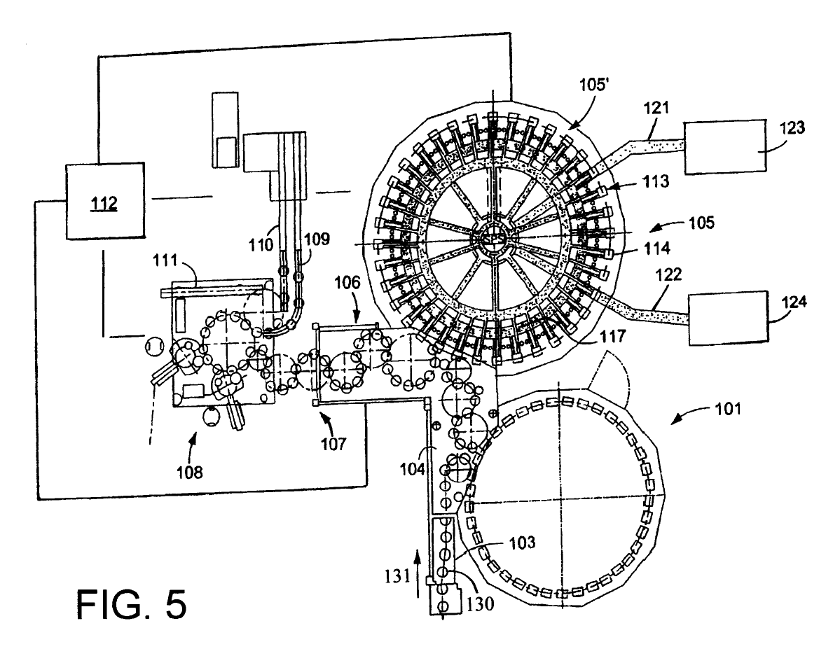

FIG. 5 shows schematically the main components of one possible embodiment example of a system for filling containers, specifically, a beverage bottling plant for filling bottles 130 with at least one liquid beverage, in accordance with at least one possible embodiment, in which system or plant could possibly be utilized at least one aspect, or several aspects, of the embodiments disclosed herein.

FIG. 5 shows a rinsing arrangement or rinsing station 101, to which the containers, namely bottles 130, are fed in the direction of travel as indicated by the arrow 131, by a first conveyer arrangement 103, which can be a linear conveyor or a combination of a linear conveyor and a starwheel. Downstream of the rinsing arrangement or rinsing station 101, in the direction of travel as indicated by the arrow 131, the rinsed bottles 130 are transported to a beverage filling machine 105 by a second conveyer arrangement 104 that is formed, for example, by one or more starwheels that introduce bottles 130 into the beverage filling machine 105.

The beverage filling machine 105 shown is of a revolving or rotary design, with a rotor 105′, which revolves around a central, vertical machine axis. The rotor 105′ is designed to receive and hold the bottles 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles 130 to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 5, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle 130, the first product or the second product can be filled by means of an appropriate control of the filling product or fluid valves.

Downstream of the beverage filling machine 105, in the direction of travel of the bottles 130, there can be a beverage bottle closing arrangement or closing station 106 which closes or caps the bottles 130. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles 130. In the embodiment shown, the labeling arrangement 108 is connected by a starwheel conveyer structure to three output conveyer arrangements: a first output conveyer arrangement 109, a second output conveyer arrangement 110, and a third output conveyer arrangement 111, all of which convey filled, closed, and labeled bottles 130 to different locations.

The first output conveyer arrangement 109, in the embodiment shown, is designed to convey bottles 130 that are filled with a first type of liquid beverage supplied by, for example, the supply reservoir 123. The second output conveyer arrangement 110, in the embodiment shown, is designed to convey bottles 130 that are filled with a second type of liquid beverage supplied by, for example, the supply reservoir 124. The third output conveyer arrangement 111, in the embodiment shown, is designed to convey incorrectly labeled bottles 130. To further explain, the labeling arrangement 108 can comprise at least one beverage bottle inspection or monitoring device that inspects or monitors the location of labels on the bottles 130 to determine if the labels have been correctly placed or aligned on the bottles 130. The third output conveyer arrangement 111 removes any bottles 130 which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

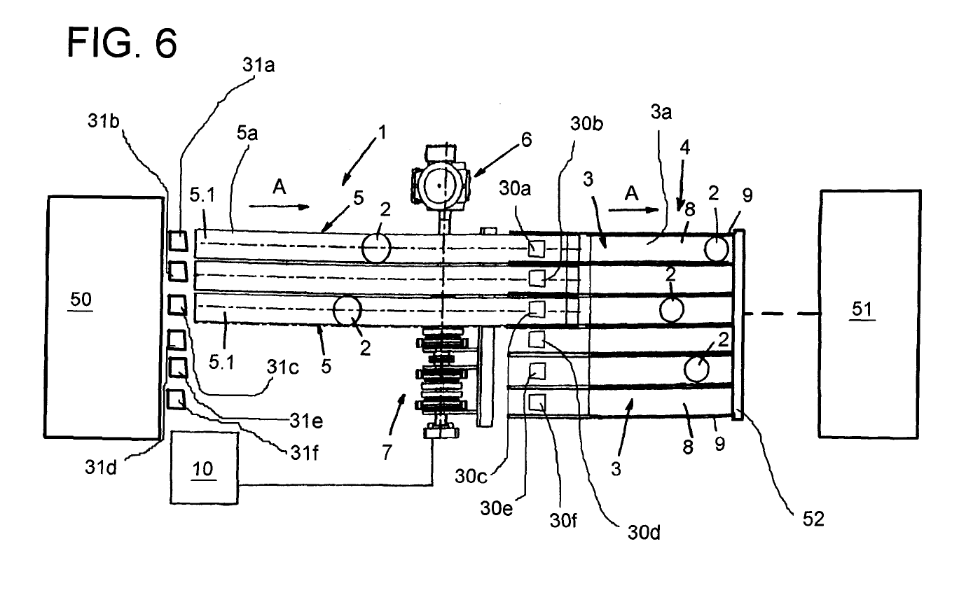

FIG. 6 shows one possible embodiment of the present application, in which bottles or similar beverage containers 2 are moved from a treatment machine 50, which may comprise a filling machine, capping and/or closing machine 50, or a labeling machine 50, to a packaging machine 51. The containers 2 are moved to the conveyor or meter belt 1 of the present application. The n1 speed of the conveyor is about ten percent lower than both the production speed of the treatment machine 50 and the speed of the conveyor 8 and/or the production speed of the packaging machine 50. Sensors 30a, 30b, 30c, 30d, 30e, and 30f are disposed along a corresponding conveyor chain 5, in order to detect the containers passing along each conveyor 5. If one individual lane 3 has a lesser amount of containers or bottles 2 than any other lane 3, as detected or sensed by the plurality of sensors 30a, 30b, 30c, 30d, 30e, and 30f, then the electronic control device 10 increases the speed of the corresponding conveyor chain by twenty percent of n1, producing a speed n2. The speed n2 is ten percent higher than the production speeds of both the treatment machine 50 and the packaging machine 51.

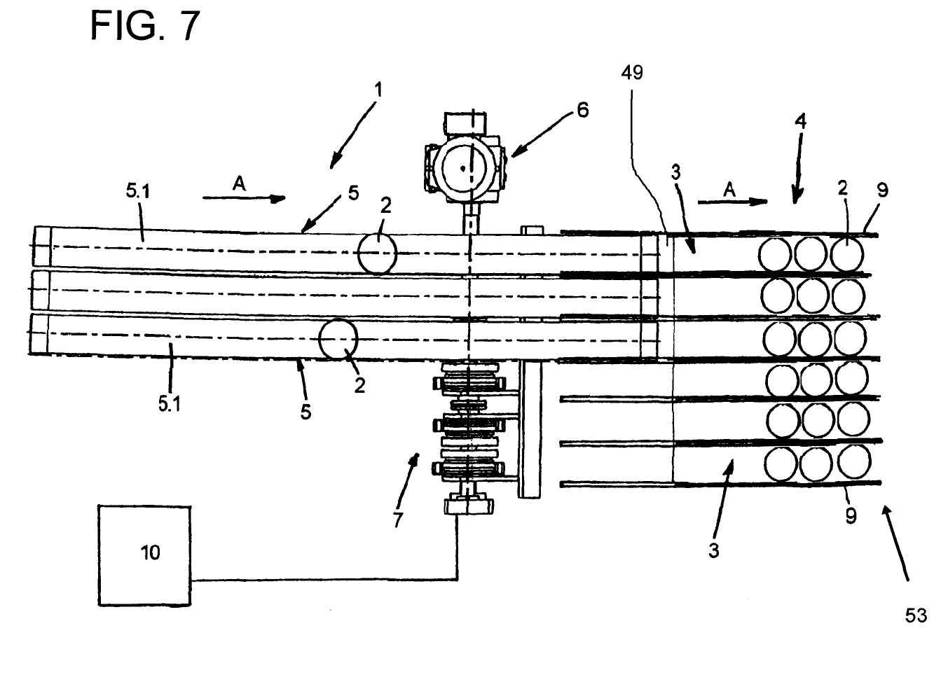

Also seen in FIG. 6, along with additional sensors 31a, 31b, 31c, 31d, and 31e, is a gating arrangement or arm 52, which in one possible embodiment blocks the bottles or containers 2 in the individual lanes 3 from passing from the conveyor 8 to the packaging or packing machine 51. The gating arrangement or arm 52 restricts and/or minimizes bottles or containers 2 from being fed into the packaging machine 51 until it is desired to do so. Additionally, the gating arrangement or arm 52 promotes the formation of a buffer area 53, which is seen in more detail in FIG. 7.

FIG. 7 shows another possible embodiment of the present application, in which the bottles or similar beverage containers 2 are being transported down the meter belt 1 by the conveyor chains 5 and transported into the individual lanes 3. The bottles or containers 2 are being transported on the meter belt 1 at a higher speed than the speed at which the containers 2 are being taken off the meter belt 1. This difference in speed produces a build-up of containers 2 in the individual lanes 3. The bottles 2 then form rows in the individual lanes 3. The conveyor chains 5 can be moved at different speeds, to promote that an even number of bottles or containers 2 are transported into each of the individual lanes 3.

Additionally seen in FIG. 7 is the buffer area 53. The gating arrangement or arm 52, not seen here, restricts or minimizes any bottles or containers 2 from exiting the buffer area 53, until the exiting of bottles or containers 2 from the buffer area 53 is desired. The gating arrangement or arm 52 promotes that a sufficient buffer amount of bottles or containers 2, so that a sufficient amount of bottles 2 are available to be accepted into the packaging machine 51. The sensors 30a, 30b, 30c, 30d, 30e, and 30f count the number of bottles 2 passing in each lane 3. If a sensor 30a detects that an insufficient number of bottles 2 are not entering into its corresponding lane 3a, the sensor 30a then sends a signal to the control unit 10. The control unit 10 then sends a signal to the transmission 7. The transmission 7 then speeds up the corresponding set of gears to increase the speed of the corresponding conveyor belt 5a, so that bottles 2 will enter the buffer area 53 in the lane 3a, to promote that a sufficient amount of bottles or containers 2 will be in each of the lanes 3 in the buffer area 53.

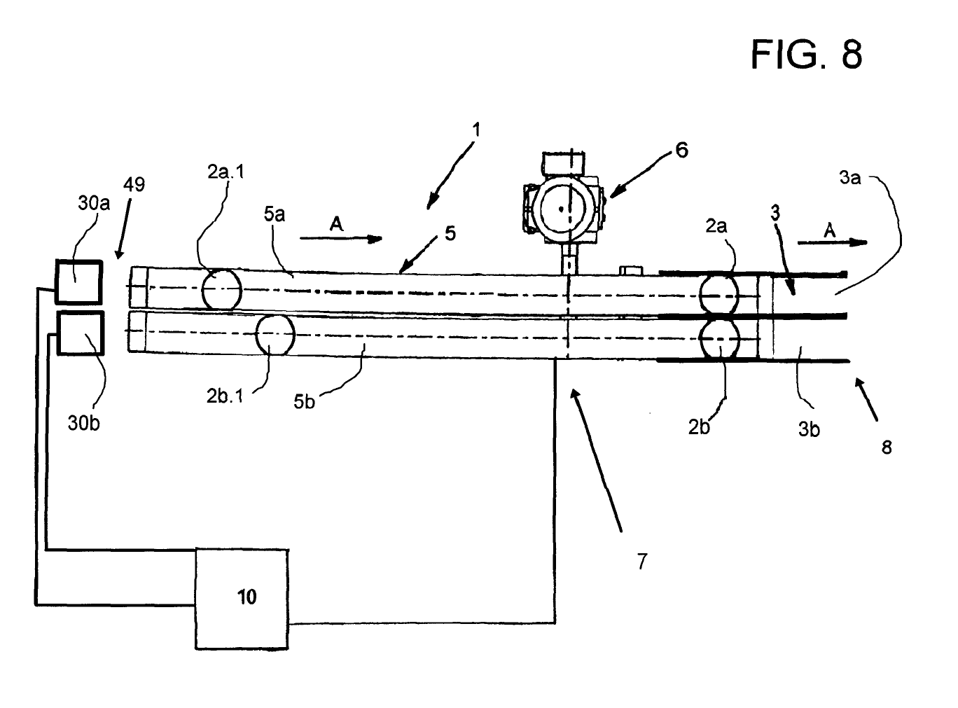

FIG. 8 shows the meter belt 1 of the present application with two conveyor belts 5a and 5b, which transport beverage bottles or similar containers 2 toward a conveyor 8. The conveyors 5a and 5b are driven at varying speeds in order to substantially align the bottles or containers 2, which are being conveyed down the meter belt 1. As seen in FIG. 8, the containers or items 2a and 2b have traveled down the horizontal length of their corresponding belts 5a and 5b and are moving to the conveyor 8 substantially synchronously or virtually at the same time. Meanwhile, the next group of bottles or containers 2a.1 and 2b.1 have passed by their corresponding sensors 30a and 30b. The bottles 2a.1 and 2b.1 are not aligned. The sensors 30a and 30b send signals to the control unit 10, and the control unit 10 sends a signal to the transmission 7, which is located under the conveyor belts 5a and 5b. The set of gears under the belt 5a speed up the belt 5a in order to align the bottle 2a.1 with the bottle 2b.1. In another possible embodiment, the belt 5b is slowed in order to align the bottle 2b.1 with the bottle 2a.1. Once the bottles 2a.1 and 2b.1 are substantially aligned, the belts 5a and 5b are driven at the same speed by the transmission 7.

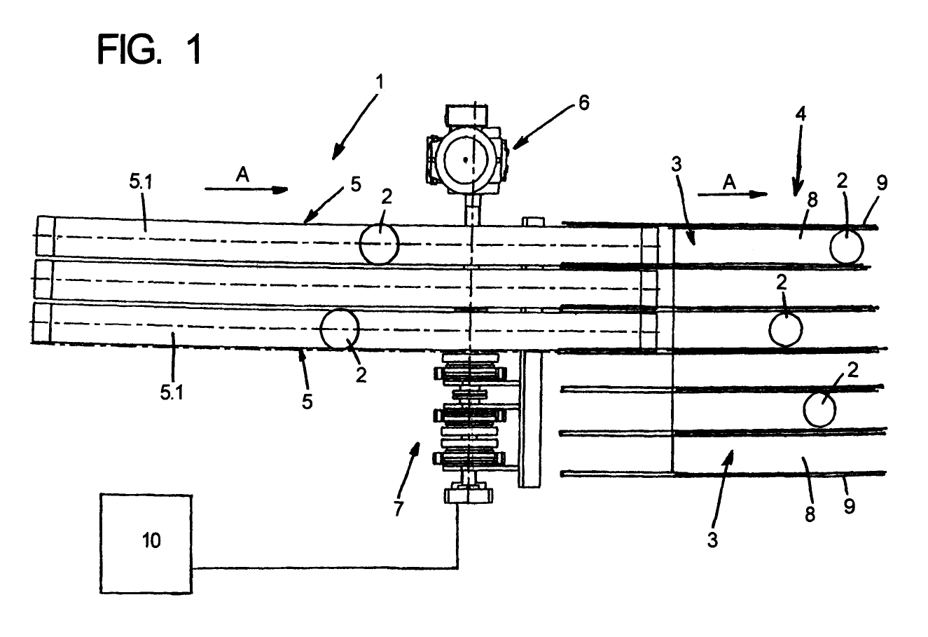

In this embodiment illustrated in FIG. 8, the belts are sufficiently long to have a sufficient distance between groups of bottles or similar containers 2 so that once a first, aligned group of bottles 2 have been transferred from the belts 5 to the conveyor 8, a second group of bottles 2 have sufficient time to be aligned before a third group of bottles 2 have moved onto the conveyor 5a and 5b. The embodiments of FIGS. 6 and 7 can be adapted to work similarly, and the embodiment of FIG. 8 can be adapted to include more conveyors like the embodiments seen in FIGS. 1, 6, and 7.

Each group of bottles 2 is often or may be sometimes transferred from the treatment machine to the meter belt 1 in a disoriented, disorganized, or misaligned group. For example, a bottle or container 2 of one group may enter the meter belt 1 before the other bottles 2 of the same group, or each of the bottles will be transferred in a staggered manner. The bottles 2 should ultimately be transferred from the conveyor belts 5 to the conveyor 8 in a single row, or with each bottle 2 in the group adjacent one another. In order to align the bottles 2 in a disoriented or disorganized group, the speed of each of the conveyor belts 5 may be varied. Once the bottles 2 are then in a row or substantially aligned with one another, the belts 5 then run at the same speed until the group of aligned bottles 2 are transferred from the belts 5 to the conveyor 8 at a transfer point 49.

In another possible embodiment according to the present application, the speeds of the belts 5 are sufficiently fast so that once a first, aligned group of bottles 2 have been transferred from the belts 5 to the conveyor 8, a second group of bottles 2 have sufficient time to be aligned before a third group of bottles 2 move past the sensors 30a and 30b.

The present application was described above with reference to a single possible embodiment. It goes without saying that numerous modifications and variations can be made without thereby going beyond the teaching of the present application.

For example, it is possible to provide, instead of the toothed belt drives 18 and 22, additional chain drives and/or to realize the driving connection between the main drive shaft 11 and the lay shaft 14 and/or between the conveyor chain drive wheels 12 and the couplings located on the lay shaft 14 in some other manner.

The components disclosed in the various publications, disclosed or incorporated by reference herein, may possibly be used in possible embodiments of the present invention, as well as equivalents thereof.

Meter belt for use in a conveyor line for the transport of products, with at least two endless circulating conveyor belts that can be driven by a drive mechanism, which conveyor belts are laterally adjacent to one another with the respective upper lengths of their loops and form a common horizontal or essentially horizontal transport surface for the products, whereby the speed of circulation and thus the speed of transport of the conveyor belts can be set individually.

One feature or aspect of an embodiment is believed at the time of the filing of this patent application to possibly reside broadly in a meter belt for use in a conveyor line for the transport of products, with at least two endless conveyor belts 5 that can be driven in circulation and form a loop, which conveyor belts, with the respective upper lengths 5.1 of their loops laterally adjacent to one another, form a common transport surface for the products 2, whereby the speed of circulation and thus the transport speed of at least one conveyor belt 5 can be set individually, wherein the drive system is formed by a single drive motor 6, and that a gearing in the form of a transmission 7 is realized that connects the conveyor belts 5 so that they are driven by the drive motor 6 so that the speed of at least one conveyor belt 5 can be varied in steps by changing gears.

Another feature or aspect of an embodiment is believed at the time of the filing of this patent application to possibly reside broadly in the meter belt, wherein the speed of the at least one conveyor belt 5 can be shifted between a first speed and a second speed.

Yet another feature or aspect of an embodiment is believed at the time of the filing of this patent application to possibly reside broadly in the meter belt, wherein it has at least four endless conveyor belts 5 which can be driven in circulation and each of which forms a closed loop, are laterally adjacent to one another with their upper loop lengths and form a common transport surface for the products 2.

Still another feature or aspect of an embodiment is believed at the time of the filing of this patent application to possibly reside broadly in the meter belt, wherein it has at least six endless conveyor belts 5 which can be driven in circulation and each of which forms a closed loop, which are laterally adjacent to one another with their upper loop lengths and form a common transport surface for the products 2.

A further feature or aspect of an embodiment is believed at the time of the filing of this patent application to possibly reside broadly in the meter belt, wherein by means of the transmission 7, the speed of at least some of the conveyor belts 5, in one possible embodiment the speed of each conveyor belt individually, can be varied in steps.

Another feature or aspect of an embodiment is believed at the time of the filing of this patent application to possibly reside broadly in the meter belt, wherein the transmission 7 for each switchable conveyor belt 5 has at least one conveyor belt drive wheel 12, by means of which the at least one switchable conveyor belt 5 is guided and which is connected in a driving connection by means of an over-revving coupling element 13 with a main shaft 11 which is driven by the drive motor 6, that the at least one conveyor belt drive wheel 12 of each switchable conveyor belt 5 is also connected for drive purposes by means of an activatable and deactivatable drive train 18, 22, 23 inside the transmission with a shaft that can be driven by the drive motor 6, for example with the main shaft 11, that the drive train 18, 22, 23 inside the transmission is realized with a translation ratio such that when the drive train 18, 22, 23 inside the transmission is activated, the at least one conveyor belt drive wheel 12 is driven at a speed which is greater than the speed of the drive via the over-revving coupling element 13, and that the over-revving coupling element 13 is realized so that an over-revving of the conveyor belt drive wheel 12 is possible at a speed which is greater than the speed when the conveyor belt drive wheel 12 is being driven via the over-revving coupling element.

Yet another feature or aspect of an embodiment is believed at the time of the filing of this patent application to possibly reside broadly in the meter belt, wherein at least one conveyor belt drive wheel 12 is provided for each conveyor belt 5, which is connected via the over-revving coupling element 13 and simultaneously or substantially simultaneously via a drive train 18, 22, 23 inside the transmission in a driving connection with the main shaft 11.

Still another feature or aspect of an embodiment is believed at the time of the filing of this patent application to possibly reside broadly in the meter belt, wherein the at least one conveyor belt drive wheel 12 at least of the at least one switchable conveyor belt 5 is located with the over-revving coupling element 13 on the main shaft 11.

A further feature or aspect of an embodiment is believed at the time of the filing of this patent application to possibly reside broadly in the meter belt, wherein for each switchable conveyor belt 5 there is an individual drive train 18, 22, 23 inside the transmission, which drive train can be turned on and off individually.

One feature or aspect of an embodiment is believed at the time of the filing of this patent application to possibly reside broadly in the meter belt, wherein the over-revving coupling element is a freewheel mechanism 13.

Another feature or aspect of an embodiment is believed at the time of the filing of this patent application to possibly reside broadly in the meter belt, wherein the drive train 18, 22, 23 which can be turned on and off has a switchable coupling that effects the turning on and off.

Yet another feature or aspect of an embodiment is believed at the time of the filing of this patent application to possibly reside broadly in the meter belt, comprising a lay shaft 14 which is connected via a first segment 18 of the drive train inside the transmission in a driving connection with the main shaft 11, and is connected in a controlled manner via a second segment 22 of the drive train inside the transmission with the at least one conveyor belt drive wheel 12 of the at least one switchable conveyor belt 5.

Still another feature or aspect of an embodiment is believed at the time of the filing of this patent application to possibly reside broadly in the meter belt, wherein the first and/or second segment 22 of the internal drive train is formed by a belt drive, in one possible embodiment a toothed belt drive, or by a chain drive.

A further feature or aspect of an embodiment is believed at the time of the filing of this patent application to possibly reside broadly in the meter belt, wherein the coupling 23 and a wheel 19 of the second segment of the at least one drive train inside the transmission are provided on the lay shaft 14.

Another feature or aspect of an embodiment is believed at the time of the filing of this patent application to possibly reside broadly in the meter belt, wherein the lay shaft 14 and the first segment 18 of the drive train inside the transmission that connects this lay shaft in a driving relationship with the main shaft are provided for all or substantially all or most of the switched conveyor belts 5 or for their conveyor belt drive wheels 13.

Yet another feature or aspect of an embodiment is believed at the time of the filing of this patent application to possibly reside broadly in the meter belt, wherein the drive motor is a geared motor 6.

Still another feature or aspect of an embodiment is believed at the time of the filing of this patent application to possibly reside broadly in the meter belt, wherein the conveyor belts 5 are conveyor chains.

A further feature or aspect of an embodiment is believed at the time of the filing of this patent application to possibly reside broadly in the meter belt, wherein the at least one switchable conveyor belt 5 can be driven by means of the transmission 7 optionally at a first speed n1 and at a second speed n2 which is approximately twenty percent faster.

One feature or aspect of an embodiment is believed at the time of the filing of this patent application to possibly reside broadly in the meter belt as a component of a conveyor line with at least one additional conveyor belt 8 which is upstream of the meter belt 1 in the direction of transport A and/or is downstream of the meter belt 1 in the direction of transport A, wherein the at least one switchable conveyor belt 5 of the meter belt 1 can be driven by means of the drive motor 6 and the transmission 7 such that the lower speed is approximately ten percent below and the higher speed is approximately ten percent above the transport speed of the at least one upstream and/or of the at least one downstream conveyor belt 8.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

U.S. Pat. No. 7,165,667, issued on Jan. 23, 2007, having inventors Horst BÖCKER, Berthold PAROTH, and Ulrich SCHOLZ, Attorney Docket No. NHL-HOL-63, and title “BEVERAGE BOTTLING PLAN FOR FILLING BEVERAGE BOTTLES OR OTHER BEVERAGE CONTAINERS WITH A LIQUID BEVERAGE FILLING MATERIAL AND AN ARRANGEMENT FOR DIVIDING AND SEPARATING OF A STREAM OF BEVERAGE BOTTLES OR OTHER BEVERAGE CONTAINERS,” and U.S. application Ser. No. 10/723,451, and filing date Nov. 26, 2003, and its corresponding Federal Republic of Germany Patent Application No. 102 55 814, filed on Nov. 29, 2002, are hereby incorporated by reference as if set forth in their entirety herein. Other examples of arrangements which produce a plurality of rows of beverage bottles or other containers which may possibly be utilized adapted for use in at least one possible embodiment of the present application may possibly be found in the following U.S. patents: U.S. Pat. No. 4,844,234, having the title “ARRANGEMENT FOR CONVERTING A MULTI-TRACK STREAM OF CONTAINERS INTO A PLURALITY OF PARALLEL CONTAINER ROWS THAT ARE SEPARATED FROM ONE ANOTHER BY SEPARATING ELEMENTS,” issued on Jul. 4, 1989; and U.S. Pat. No. 4,060,166, having the title “CONTAINER SEPARATOR,” issued on Nov. 29, 1977.

Some examples of guide arms, bars, webs, or spacers or beverage bottle treatment machines comprising guide arms, bars, webs, or spacers which may possibly be utilized or adapted for use in at least one possible embodiment of the present application may possibly be found in the following U.S. patents: U.S. Pat. No. 7,392,630, having the title “PACKAGING SYSTEM HAVING LOADING CAROUSEL,” published on Jul. 1, 2007; U.S. Pat No. 7,481,309, having the title “METHOD OF SEPARATING, SYNCHRONIZING AND COMPACTING PACKED GROUPS OF ARTICLES,” published on Jan. 27, 2009; U.S. Pat. No. 4,709,800, having the title “BOTTLE CONVEYOR WITH BRUSH SPACER,” published Dec. 1, 1987; and U.S. Pat. No. 4,163,352, having the title “BOTTLE PACKAGING MACHINE,” published on Aug. 7, 1979.

Some examples of labeling machines which may possibly be utilized in at least one possible embodiment may possibly be found in the following U.S. patents: U.S. Pat. No. 6,634,400, entitled “Labeling machine;” U.S. Pat. No. 6,561,246, entitled “Labeling machine capable of precise attachment of a label to different sizes of containers;” U.S. Pat. No. 6,550,512, entitled “Labeling machine capable of preventing erroneous attachment of labels on containers;” U.S. Pat. No. 6,543,514, entitled “In-line continuous feed sleeve labeling machine and method;” U.S. Pat. No. 6,378,587, entitled “Cylindrical container labeling machine;” U.S. Pat. No. 6,328,086, entitled “Labeling machine;” U.S. Pat. No. 6,315,021, entitled “Labeling machine;” U.S. Pat. No. 6,263,940, entitled “In-line continuous feed sleeve labeling machine and method;” U.S. Pat. No. 6,199,614, entitled “High speed labeling machine having a constant tension driving system;” U.S. Pat. No. 6,167,935, entitled “Labeling machine; U.S. Pat. No. 6,066,223, entitled “Labeling machine and method; U.S. Pat. No. 6,050,319, entitled “Non-round container labeling machine and method;” and U.S. Pat. No. 6,045,616, entitled “Adhesive station and labeling machine.”

The Innopack packaging machine, manufactured by KHS Maschinen und Anlagenbau AG, is an example of a packaging machine which may possibly be utilized or adapted for use in at least one possible embodiment. Some other examples of packaging machines which may possibly be utilized or adapted for use in at least one possible embodiment may possibly be found in the following U.S. patents: U.S. Pat. No. 4,964,260, entitled “Packaging machine for cardboard boxes and process for packaging articles in cardboard boxes;” U.S. Pat. No. 4,785,610, entitled “Automatic machine for packaging products of different kinds in boxes;” U.S. Pat. No. 5,265,398, entitled “Automatic counting and boxing machine;” U.S. Pat. No. 5,943,847, entitled “Packaging machine for multi-packs;” U.S. Pat. No. 5,937,620, entitled “Packaging machine for multi-packs;” U.S. Pat. No. 5,711,137, entitled “Packaging machine and method of packaging articles;” and U.S. Pat. No. 5,706,633, entitled “Packaging machine and method of packaging articles.”

Some examples of closing machines and/or capping machines which may possibly be utilized or adapted for use in at least one possible embodiment according to the present application may possibly be found in the following U.S. patents: U.S. Pat. No. 7,415,816, having the title “BEVERAGE BOTTLING PLANT HAVING A BEVERAGE BOTTLE CLOSING MACHINE WITH A BEARING SYSTEM TO GUIDE A RECIPROCATING SHAFT IN THE BEVERAGE BOTTLE CLOSING MACHINE,” published on Aug. 26, 2008; U.S. Pat. No. 7,325,372, having the title “BEVERAGE BOTTLING PLANT FOR FILLING BOTTLES WITH A LIQUID BEVERAGE MATERIAL HAVING A BOTTLE CLOSING MACHINE FOR APPLYING SCREW CAPS TO BOTTLES,” published on Feb. 5, 2008; U.S. Pat. No. 7,165,582, having the title “BEVERAGE BOTTLING PLANT FOR FILLING BOTTLES WITH A LIQUID BEVERAGE FILLING MATERIAL, A BEVERAGE CONTAINER FILLING MACHINE, AND A BEVERAGE CONTAINER CLOSING MACHINE,” published on Jan. 23, 2007; U.S. Pat. No. 7,162,849, having the title “BEVERAGE BOTTLING PLANT FOR FILLING BOTTLES WITH A LIQUID BEVERAGE MATERIAL HAVING A BOTTLE CLOSING DEVICE, AND A CLOSURE APPLYING MACHINE FOR CLOSING OF CONTAINERS, SUCH AS BOTTLES, CANS, CANISTERS, OR THE LIKE, BY WAY OF SCREWING ON OF SCREW CAPS,” published on Jan. 16, 2007; U.S. Pat. No. 6,619,016, having the title “METHOD FOR FILLING AND CAPPING CONTAINERS SUCH AS SCREW TOP BOTTLES AND THE SCREW TOP CLOSURES THEREFORE,” published on Sep. 16, 2003; and U.S. Pat. No. 6,484,477, having the title “CAPPING MACHINE FOR CAPPING AND CLOSING CONTAINERS, AND A METHOD FOR CLOSING CONTAINERS,” published on Nov. 26, 2002.

All of the patents, patent applications or patent publications, which were cited in the International Search Report dated Jan. 24, 2008, and/or cited elsewhere are hereby incorporated by reference as if set forth in their entirety herein as follows: US 2004/104100, having the title “CONVEYOR SYSTEM WITH DISTRIBUTED ARTICLE MANIPULATION,” published on Jun. 3, 2004; and WO 2006/002156, having the title “HIGH-RATE SPACE EFFICIENT ARTICLE SINGULATOR,” published on Jan. 5, 2006.

All of the patents, patent applications or patent publications, which were cited in the German Office Action dated Apr. 19, 2007, and/or cited elsewhere are hereby incorporated by reference as if set forth in their entirety herein as follows: DE 20 2005 013 125, having the following English translation of the German title “SINGLE-LANE CONTAINER E.G. BOTTLE, FLOW FORMING APPARATUS, HAS CONVEYORS FOR CONTAINER FLOW, INTERMEDIATE AREA CONNECTED IN CONVEYOR, AND SEPARATING AREA CONNECTING INTERMEDIATE AREA WITH CONVEYORS,” published on Nov. 3, 2005; and DE 42 13 557, having the following English translation of the German title “BOTTLE OR CAN MULTI-ROW STREAM FORMING OUT OF SINGLE ROW—BY CONTINUOUSLY REDUCING SINGLE ROW VELOCITY IN TWO PHASES, ONE FOR GAP CLOSING AND SECOND ONE FOR MULTI-ROW FORMATION,” published on Oct. 28, 1993.

The patents, patent applications, and patent publication listed above, beginning on line 718 on page 35 in the paragraph with the phrase: “U.S. Pat. No. 7,165,667 . . . ” and ending on line 835 on page 40 in the paragraph with the phrase: “ . . . published on Oct. 28, 1993” are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 039 086.5, filed on Aug. 19, 2006, having inventors Bernd COX and Stefan WILLEMSEN, and DE-OS 10 2006 039 086.5 and DE-PS 10 2006 039 086.5, and International Application No. PCT/EP2007/007205, filed on Aug. 16, 2007, having WIPO Publication No. WO 2008/022734 and inventors Bernd COX and Stefan WILLEMSEN, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the Foreign equivalent patent application PCT/EP2007/007205 and German Patent Application 10 2006 039 086.5 is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/007205 and DE 10 2006 039 086.5 from which this patent application claims priority which do not have to do with the correction of the translation in this patent application are not to be included in this patent application in the incorporation by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

1 Meter belt
2 Product
3 Lane
4 Conveyor
5 Single belt or conveyor chain
5.1 Top loop length of the conveyor chain 5
5.2 Bottom loop length of the conveyor chain 5
6 Geared motor
7 Transmission
8 Conveyor belt
9 Rails
10 Control device
11 Main drive shaft
12 Conveyor chain drive wheel
13 Freewheel
14 Lay shaft
14.1 Segment of the lay shaft 14
15 Toothed belts
16, 17 Toothed belt sprocket
18 Toothed belt drive
19 Toothed belt sprocket
20 Toothed belts
21 Toothed belt sprocket
22 Toothed belt drive
23 Controllable, e.g. electrically actuated coupling
24 Flange
A Direction of transport

What is claimed is:

1. A conveying apparatus for the conveying of beverage bottles from a beverage bottle treatment machine, such as a beverage bottle closing machine and/or beverage bottle labeling machine, to a beverage bottle packaging machine in a beverage bottling plant, said conveying apparatus comprising:
at least six parallel conveyor belts being disposed laterally adjacent to one another and further being configured and disposed to transport beverage bottles from said beverage bottle treatment machine, such as a beverage bottle closing machine and/or beverage bottle labeling machine;
each of said at least six parallel conveyor belts comprising an endless loop;
an additional conveyor being configured and disposed to transport beverage bottles from said at least six parallel conveyor belts to said beverage bottle packaging machine;
at least a portion of each of said endless loops comprising a horizontal length extending from said beverage bottle treatment machine, such as a beverage bottle closing machine and/or beverage bottle labeling machine, to said additional conveyor;
a plurality of rail guides, each of said plurality of rail guides being disposed between each of said at least six parallel conveyor belts and extending from at least a portion of said horizontal length of each of said at least six parallel conveyor belts and along at least a portion of said additional conveyor;
said plurality of rail guides being further disposed substantially parallel with respect to one another to form lanes, into which beverage bottles are fed by said at least six parallel conveyor belts;
each of said lanes comprising at least a portion of said horizontal length of said at least six parallel conveyor belts and at least a portion of said additional conveyor;
said plurality of rail guides being configured to guide beverage bottles into each of said lanes;
a sole motor being configured and disposed to drive said at least six parallel conveyor belts;
a transmission being configured and disposed to connect said sole motor and each of said at least six parallel conveyor belts, and being further configured to drive each of said at least six parallel conveyor belts at either one of: a first speed or a second speed;
said first speed being less than the beverage bottle output rate of said beverage bottle treatment machine, such as a beverage bottle closing machine and/or a beverage bottle labeling machine and less than the beverage bottle output rate of said beverage bottle packaging machine;
said second speed being greater than the beverage bottle output rate of said beverage bottle treatment machine, such as a beverage bottle closing machine and/or a beverage bottle labeling machine and more than the beverage bottle output rate of said beverage bottle packaging machine;
a plurality of sensors being configured and disposed to sense the position of beverage bottles being disposed in each of said lanes;
a control unit being configured and disposed:
to receive signals from said plurality of sensors;
to send signals to said transmission to either increase or decrease the speed of at least one of said at least six parallel conveyor belts, upon said plurality of sensors sensing a position of a first beverage bottle on a first conveyor belt not being aligned with a second beverage bottle on a second conveyor belt to thus align the first beverage bottle on the first conveyor belt adjacent the second beverage bottle on the second conveyor belt, such that the first beverage bottle and the second beverage bottle arrive at said additional conveyor substantially simultaneously; and
to align a further beverage bottle on a further conveyor belt with the first beverage bottle and the second beverage bottle upon transfer from said at least six parallel conveyor belts to said additional conveyor, such that all beverage bottles on all said at least six parallel conveyor belts arrive at said additional conveyor substantially simultaneously;
a portion of said additional conveyor being disposed closer to said beverage bottle packaging machine than any other portion of said additional conveyor comprising a buffer area configured to hold a sufficient, buffer amount of beverage bottles; and
a gating arrangement being configured and disposed to restrict or minimize beverage bottles from exiting said buffer area.

2. Meter belt as recited in claim 1, characterized in that:
by means of the transmission (7), the speed of at least some of the conveyor belts (5), preferably the speed of each conveyor belt individually, can be varied in steps;
the transmission (7) for each switchable conveyor belt (5) has at least one conveyor belt drive wheel (12), by means of which the at least one switchable conveyor belt (5) is guided and which is connected in a driving connection by means of an over-revving coupling element (13) with a main shaft (11) which is driven by the drive motor (6), that the at least one conveyor belt drive wheel (12) of each switchable conveyor belt (5) is also connected for drive purposes by means of an activatable and deactivatable drive train (18, 22, 23) inside the transmission with a shaft that can be driven by the drive motor (6), for example with the main shaft (11), that the drive train (18, 22, 23) inside the transmission is realized with a translation ratio such that when the drive train (18, 22, 23) inside the transmission is activated, the at least one conveyor belt drive wheel (12) is driven at a speed which is greater than the speed of the drive via the over-revving coupling element (13), and that the over-revving coupling element (13) is realized so that an over-revving of the conveyor belt drive wheel (12) is possible at a speed which is greater than the speed when the conveyor belt drive wheel (12) is being driven via the over-revving coupling element;
at least one conveyor belt drive wheel (12) is provided for each conveyor belt (5), which is connected via the over-revving coupling element (13) and simultaneously via a drive train (18, 22, 23) inside the transmission in a driving connection with the main shaft (11);
the at least one conveyor belt drive wheel (12) at least of the at least one switchable conveyor belt (5) is located with the over-revving coupling element (13) on the main shaft (11);
for each switchable conveyor belt (5) there is an individual drive train (18, 22, 23) inside the transmission, which drive train can be turned on and off individually;
the over-revving coupling element is a freewheel mechanism (13);
the drive train (18, 22, 23) which can be turned on and off has a switchable coupling that effects the turning on and off;
the meter belt comprises a lay shaft (14) which is connected via a first segment (18) of the drive train inside the transmission in a driving connection with the main shaft (11), and is connected in a controlled manner via a second segment (22) of the drive train inside the transmission with the at least one conveyor belt drive wheel (12) of the at least one switchable conveyor belt (5);
the first and/or second segment (22) of the internal drive train is formed by a belt drive, preferably a toothed belt drive, or by a chain drive;
the coupling (23) and a wheel (19) of the second segment of the at least one drive train inside the transmission are provided on the lay shaft (14);
the lay shaft (14) and the first segment (18) of the drive train inside the transmission that connects this lay shaft in a driving relationship with the main shaft are provided for all of the switched conveyor belts (5) or for their conveyor belt drive wheels (13);
the drive motor is a geared motor (6);
the conveyor belts (5) are conveyor chains;
the at least one switchable conveyor belt (5) can be driven by means of the transmission (7) optionally at a first speed (n1) and at a second speed (n2) which is approximately 20% faster; and
said meter belt is a component of a conveyor line with at least one additional conveyor belt (8) which is upstream of the meter belt (1) in the direction of transport (A) and/or is downstream of the meter belt (1) in the direction of transport (A), characterized in that the at least one switchable conveyor belt (5) of the meter belt (1) can be driven by means of the drive motor (6) and the transmission (7) such that the lower speed is approximately 10% below and the higher speed is approximately 10% above the transport speed of the at least one upstream and/or of the at least one downstream conveyor belt (8).

3. A conveying apparatus for the conveying of containers from a container treatment machine, such as a container closing machine or container labeling machine, to a container packaging machine in a container plant, said conveying apparatus comprising:
at least two substantially parallel conveyor belts being disposed laterally adjacent to one another and further being configured and disposed to transport containers from said container treatment machine, such as a container closing machine or container labeling machine;
each of said at least two substantially parallel conveyor belts comprising an endless loop;
an additional conveyor being configured and disposed to transport containers from said at least two substantially parallel conveyor belts to said container packaging machine;
at least a portion of each of said endless loops comprising a substantially horizontal length extending from said container treatment machine, such as a container closing machine or container labeling machine, to said additional conveyor which additional conveyor is configured to feed containers into said container packaging machine;
a plurality of rail guides, each of said plurality of rail guides being disposed between each of said at least two substantially parallel conveyor belts and extending from at least a portion of said substantially horizontal length of each of said at least two substantially parallel conveyor belts and along at least a portion of said additional conveyor;
said plurality of rail guides being further disposed substantially parallel with respect to one another to form lanes, into which containers are fed by said at least two substantially parallel conveyor belts;
each of said lanes comprising at least a portion of said substantially horizontal length of said at least two substantially parallel conveyor belts and at least a portion of said additional conveyor;
said plurality of rail guides being configured to guide containers into each of said lanes;
a motor arrangement being configured and disposed to drive said at least two substantially parallel conveyor belts;
a conveyor belt speed control arrangement being configured and disposed to connect said motor arrangement and each of said at least two substantially parallel conveyor belts, and being further configured to drive each of said at least two substantially parallel conveyor belts at either one of: a first speed or a second speed;
said first speed being less than the container output rate of said container treatment machine, such as a container closing machine or a container labeling machine and less than the container output rate of said container packaging machine;
said second speed being greater than the container output rate of said container treatment machine, such as a container closing machine or a container labeling machine and more than the container output rate of said container packaging machine;
a sensor arrangement being configured and disposed to sense the position of containers being disposed in each of said lanes;
a control unit being configured and disposed:
to receive signals from said sensor arrangement;
to send signals to said conveyor belt speed control arrangement to either increase or decrease the speed of at least one of said at least two substantially parallel conveyor belts, upon said sensor arrangement sensing a position of a first container on a first conveyor belt not being aligned with a second container on a second conveyor belt to thus align the first container on the first conveyor belt with the second container on the second conveyor belt, such that the first container and the second container arrive at said additional conveyor substantially simultaneously; and
to align any further container on any further conveyor belt with the first container and the second container upon transfer from said at least two substantially parallel conveyor belts to said additional conveyor, such that all containers on all said at least two substantially parallel conveyor belts arrive at said additional conveyor substantially simultaneously;
a portion of said additional conveyor being disposed closer to said container packaging machine than any other portion of said additional conveyor comprising a buffer area configured to hold a sufficient, buffer amount of containers; and
a gating arrangement being configured and disposed to restrict or minimize containers from exiting said buffer area.

4. Meter belt as recited in claim 3, characterized in that:
by means of the transmission (7), the speed of at least some of the conveyor belts (5), preferably the speed of each conveyor belt individually, can be varied in steps;
the transmission (7) for each switchable conveyor belt (5) has at least one conveyor belt drive wheel (12), by means of which the at least one switchable conveyor belt (5) is guided and which is connected in a driving connection by means of an over-revving coupling element (13) with a main shaft (11) which is driven by the sole drive motor (6), that the at least one conveyor belt drive wheel (12) of each switchable conveyor belt (5) is also connected for drive purposes by means of an activatable and deactivatable drive train (18, 22, 23) inside the transmission with a shaft that can be driven by the drive motor (6), for example with the main shaft (11), that the drive train (18, 22, 23) inside the transmission is realized with a translation ratio such that when the drive train (18, 22, 23) inside the transmission is activated, the at least one conveyor belt drive wheel (12) is driven at a speed which is greater than the speed of the drive via the over-revving coupling element (13), and that the over-revving coupling element (13) is realized so that an over-revving of the conveyor belt drive wheel (12) is possible at a speed which is greater than the speed when the conveyor belt drive wheel (12) is being driven via the over-revving coupling element;
at least one conveyor belt drive wheel (12) is provided for each conveyor belt (5), which is connected via the over-revving coupling element (13) and simultaneously via a drive train (18, 22, 23) inside the transmission in a driving connection with the main shaft (11);
the at least one conveyor belt drive wheel (12) at least of the at least one switchable conveyor belt (5) is located with the over-revving coupling element (13) on the main shaft (11);
for each switchable conveyor belt (5) there is an individual drive train (18, 22, 23) inside the transmission, which drive train can be turned on and off individually;
the over-revving coupling element is a freewheel mechanism (13);
the drive train (18, 22, 23) which can be turned on and off has a switchable coupling that effects the turning on and off;
said meter belt comprises a lay shaft (14) which is connected via a first segment (18) of the drive train inside the transmission in a driving connection with the main shaft (11), and is connected in a controlled manner via a second segment (22) of the drive train inside the transmission with the at least one conveyor belt drive wheel (12) of the at least one switchable conveyor belt (5);
the first and/or second segment (22) of the internal drive train is formed by a belt drive, preferably a toothed belt drive, or by a chain drive;
the coupling (23) and a wheel (19) of the second segment of the at least one drive train inside the transmission are provided on the lay shaft (14);
the lay shaft (14) and the first segment (18) of the drive train inside the transmission that connects this lay shaft in a driving relationship with the main shaft are provided for all of the switched conveyor belts (5) or for their conveyor belt drive wheels (13);
the drive motor is a geared motor (6);
the conveyor belts (5) are conveyor chains;
the at least one switchable conveyor belt (5) can be driven by means of the transmission (7) optionally at a first speed (n1) and at a second speed (n2) which is approximately 20% faster; and
said meter belt is a component of a conveyor line with at least one additional conveyor belt (8) which is upstream of the meter belt (1) in the direction of transport (A) and/or is downstream of the meter belt (1) in the direction of transport (A), characterized in that the at least one switchable conveyor belt (5) of the meter belt (1) can be driven by means of the drive motor (6) and the transmission (7) such that the lower speed is approximately 10% below and the higher speed is approximately 10% above the transport speed of the at least one upstream and/or of the at least one downstream conveyor belt (8).

5. A conveying apparatus for the conveying of products from a product treatment machine to a product packaging machine, said conveying apparatus comprising:
at least two substantially parallel conveyor belts being disposed laterally adjacent to one another and further being configured and disposed to transport products from said product treatment machine;
each of said at least two substantially parallel conveyor belts comprising an endless loop;
an additional conveyor being configured and disposed to transport products from said at least two substantially parallel conveyor belts to said product packaging machine;
at least a portion of each of said endless loops comprising a length extending from said product treatment machine to said additional conveyor, which additional conveyor is configured to feed products into said product packaging machine;
a plurality of rail guides, each of said plurality of rail guides being disposed between each of said at least two substantially parallel conveyor belts and extending from at least a portion of said length of each of said at least two substantially parallel conveyor belts and along at least a portion of said additional conveyor;
said plurality of rail guides being further disposed substantially parallel with respect to one another to form lanes, into which products are fed by said at least two substantially parallel conveyor belts;
each of said lanes comprising at least a portion of said length of said at least two conveyor belts and at least a portion of said additional conveyor;
said plurality of rail guides being configured to guide products in each of said lanes;
a motor arrangement being configured and disposed to drive said at least two substantially parallel conveyor belts;
a conveyor belt speed control arrangement being configured and disposed to connect said motor arrangement and each of said at least two substantially parallel conveyor belts, and being further configured to drive each of said at least two conveyor belts at at least one of: a first speed or a second speed;
said first speed being less than the speed of feed of products to said conveying arrangement;
said second speed being greater than the speed of feed of products to said conveying arrangement;
a sensor arrangement being configured and disposed to sense the position of products being disposed on each of said at least two substantially parallel two conveyor belts;
a control unit being configured and disposed:
to receive signals from said sensor arrangement;
to send signals to said conveyor belt speed control arrangement to either increase or decrease the speed of at least one of said at least two conveyor belts, upon said sensor arrangement sensing a position of a first product on a first conveyor belt not being aligned with a second product on a second conveyor belt to thus substantially align the first product on the first conveyor belt in a row with the second product on the second conveyor belt; and
to substantially align any further product on any further conveyor belt of said at least two conveyor belts with the first product and the second product.

6. Meter belt as recited in claim 5, characterized in that the speed of the at least one conveyor belt (5) can be shifted between a first speed and a second speed.

7. Meter belt as recited in claim 6, characterized in that it has at least four endless conveyor belts (5) which can be driven in circulation and each of which forms a closed loop, are laterally adjacent to one another with their upper loop lengths and form a common transport surface for the products (2).

8. Meter belt as recited in claim 7, characterized in that it has at least six endless conveyor belts (5) which can be driven in circulation and each of which forms a closed loop, which are laterally adjacent to one another with their upper loop lengths and form a common transport surface for the products (2).

9. Meter belt as recited in claim 8, characterized in that by means of the transmission (7), the speed of at least some of the conveyor belts (5), preferably the speed of each conveyor belt individually, can be varied in steps.

10. Meter belt as recited in claim 9, characterized in that the transmission (7) for each switchable conveyor belt (5) has at least one conveyor belt drive wheel (12), by means of which the at least one switchable conveyor belt (5) is guided and which is connected in a driving connection by means of an over-revving coupling element (13) with a main shaft (11) which is driven by the sole drive motor (6), that the at least one conveyor belt drive wheel (12) of each switchable conveyor belt (5) is also connected for drive purposes by means of an activatable and deactivatable drive train (18, 22, 23) inside the transmission with a shaft that can be driven by the drive motor (6), for example with the main shaft (11), that the drive train (18, 22, 23) inside the transmission is realized with a translation ratio such that when the drive train (18, 22, 23) inside the transmission is activated, the at least one conveyor belt drive wheel (12) is driven at a speed which is greater than the speed of the drive via the over-revving coupling element (13), and that the over-revving coupling element (13) is realized so that an over-revving of the conveyor belt drive wheel (12) is possible at a speed which is greater than the speed when the conveyor belt drive wheel (12) is being driven via the over-revving coupling element.

11. Meter belt as recited in claim 10, characterized in that at least one conveyor belt drive wheel (12) is provided for each conveyor belt (5), which is connected via the over-revving coupling element (13) and simultaneously via a drive train (18, 22, 23) inside the transmission in a driving connection with the main shaft (11).

12. Meter belt as recited in claim 11, characterized in that the at least one conveyor belt drive wheel (12) at least of the at least one switchable conveyor belt (5) is located with the over-revving coupling element (13) on the main shaft (11).

13. Meter belt as recited in claim 12, characterized in that for each switchable conveyor belt (5) there is an individual drive train (18, 22, 23) inside the transmission, which drive train can be turned on and off individually.

14. Meter belt as recited in claim 13, characterized in that the over-revving coupling element is a freewheel mechanism (13).

15. Meter belt as recited in claim 14, characterized in that the drive train (18, 22, 23) which can be turned on and off has a switchable coupling that effects the turning on and off.

16. Meter belt as recited in claim 15, characterized by a lay shaft (14) which is connected via a first segment (18) of the drive train inside the transmission in a driving connection with the main shaft (11), and is connected in a controlled manner via a second segment (22) of the drive train inside the transmission with the at least one conveyor belt drive wheel (12) of the at least one switchable conveyor belt (5).

17. Meter belt as recited in claim 16, characterized in that the first and/or second segment (22) of the internal drive train is formed by a belt drive, preferably a toothed belt drive, or by a chain drive.

18. Meter belt as recited in claim 17, characterized in that the coupling (23) and a wheel (19) of the second segment of the at least one drive train inside the transmission are provided on the lay shaft (14).

19. Meter belt as recited in claim 18, characterized in that the lay shaft (14) and the first segment (18) of the drive train inside the transmission that connects this lay shaft in a driving relationship with the main shaft are provided for all of the switched conveyor belts (5) or for their conveyor belt drive wheels (13).

20. Meter belt as recited in claim 19, characterized in that:
the drive motor is a geared motor (6);
the conveyor belts (5) are conveyor chains;
the at least one switchable conveyor belt (5) can be driven by means of the transmission (7) optionally at a first speed (n1) and at a second speed (n2) which is approximately 20% faster; and
said meter belt is a component of a conveyor line with at least one additional conveyor belt (8) which is upstream of the meter belt (1) in the direction of transport (A) and/or is downstream of the meter belt (1) in the direction of transport (A), characterized in that the at least one switchable conveyor belt (5) of the meter belt (1) can be driven by means of the drive motor (6) and the transmission (7) such that the lower speed is approximately 10% below and the higher speed is approximately 10% above the transport speed of the at least one upstream and/or of the at least one downstream conveyor belt (8).
